(19) United States
(12) Patent Application Publication
(10) Pub. No.: US 2013/0166592 A1
(43) Pub. Date: Jun. 27, 2013

(54) METHOD FOR OBTAINING INFORMATION PROVIDED BY CONTACTS VIA NETWORK AFTER INPUTTING CONTACT INFORMATION

(71) Applicants: Lixin Zhen, Shanghai (CN); Teng Long, Shanghai (CN); Xiping Luo, Shanghai (CN)

(72) Inventors: Lixin Zhen, Shanghai (CN); Teng Long, Shanghai (CN); Xiping Luo, Shanghai (CN)

(73) Assignee: INTSIG INFORMATION CO., LTD., Yangpu District, Shanghai (CN)

(21) Appl. No.: 13/819,418

(22) PCT Filed: Aug. 2, 2011
(86) PCT No.: PCT/CN11/77897

§ 371 Date: Feb. 27, 2013

(30) Foreign Application Priority Data
Aug. 31, 2010 (CN) 201010271280.1

(51) Int. Cl. G06F 17/30

(52) U.S. Cl. CPC G06F 17/30424
USPC 707/769

(57) ABSTRACT

The present invention discloses a method for obtaining information provided by contacts via network after inputting contact information. The method includes the following steps: step A, user A obtains user B's contact information; step B, user A inputs user B's contact information to address book; step C, user A sends inquiry request to a contact information server according to user B's contact information; step D, according to the contact information submitted by user A, the contact information server searches the information stored in the server to find out whether there is some information from user B related to the contact information. If yes, it returns the related information to user A, else, it informs user A that there is no related information. This invention breaks out the limit that the name card can only transfer information with limited number of words and limited size of images, and it expands the amount of information carried by the name card and the expression forms of information.

### BACKGROUND OF THE PRESENT INVENTION

1. Field of Invention

The present invention relates to the field of computer network technologies, particularly to an information providing method, and more particularly to a method for obtaining information provided by contacts via network after inputting contact information.

2. Description of Related Arts

A business card is a medium frequently used by people and for recording and transferring contact details. In an everyday business activity, exchange of a large number of business card is usually involved. People transfer contact details by exchanging business cards, so as to establish contact with others.

The use of various social networking sites, such as, domestic QQ and kaixin as well as overseas facebook, twitter, and MSN, has become very popular in everyday life of the people. In order to use the social networking sites, a user is required to register first to become a registered user of the networks. Each registered user has a contact person list or a friends list. The user may directly perform various contact activities, including chatting, with a contact person in the contact person list. Each registered user may post a topic on a website, and upload a picture and various multimedia information including a video/audio, which may be browsed and viewed by other users. For multimedia information uploaded by a registered user, the registered user may stipulate, by setting, that the information can only be viewed by authorized users or can be viewed by all users.

A business card recognition technology currently widely applied in a mobile phone or a microcomputer uses principles of image processing and optical character recognition to perform automatic processing and recognition on a business card image obtained by a camera by photographing or obtained by a scanner by scanning, and then automatically extracts useful information therefrom, such as a name, a phone number, and an E-mail address, which are added to an address book, which makes it much more convenient for people to input contact information recorded on a business card into an electronic device. An example is business card recognition software pre-installed in a Dopod Touch Diamond mobile phone.

Due to limitation of size and material of a business card, the amount of information of a business card owner printed on the business card and the information recording means are limited. For example, a company manage cannot have a long introduction of company business thereof printed on a business card, which incurs strict limits to information borne and transferred by a business card.

### SUMMARY OF THE PRESENT INVENTION

The technical problem to be solved by the present invention is to provide a method for obtaining information provided by contacts via network after inputting contact information, so as to eliminate the limit that a business card can only transfer information through a limited quantity of text and through limited size of a picture, thereby increasing the quantity of information borne and transferred by the business card and add a manifestation of information.

In order to solve the technical problem, the present invention adopts the following technical solutions.

A method for obtaining information provided by contacts via network after inputting contact information includes the following steps.

Step A: A user A obtains contact information of a user B.

Step B: The user A inputs the contact information of the user B into an address book.

Step C: The user A sends a inquery request to a contact information server according to the contact information of the user B.

Step D: According to the contact information submitted by user A, the contact information server searches the information stored in the server to find out whether there is some information from user B related to the contact information; if yes, proceed to Step E; otherwise, proceed to Step F.

Step E: The contact information server returns the information stored by the user B on the website and associated with the contact information to the user A.

Step F: The contact information server returns that no information associated with the contact information can be provided.

Step G: End.

According to a preferred solution of the present invention, in Step B, the user A inputs the contact information of the user B into the address book through one of the following methods.

In a first method, the user A directly manually inputs the contact information of the user B.

In a second method, the user A obtains an image including the contact information of the user B by photographing or scanning, and uses character recognition software to automatically recognize and extract information in the image.

According to a preferred solution of the present invention, in Step D, the contact information server determines, according to the contact information submitted by the user A, whether the multimedia information stored by the user B on the server and associated with the contact information can be found. The contact information server is required to determine whether the user B is a registered user of the contact information server, whether the user B stores the information associated with the business card, and whether the user B allows other users, submitting a request, to obtain the information.

According to a preferred solution of the present invention, the method for the contact information server to perform inquery regarding the user B includes the following steps.

Step D1: Obtain information of a business card stored by a registered user of the contact information server.

Step D2: Match a name, a phone number, a mobile phone number, a fax number and E-mail information included in the textual information of the business card submitted by the user A with corresponding information in the business card information item by item, so as to obtain the number of items of information that is completely consistent, and the number of items of information that is different in only a few of characters.

Step D3: Determine whether the textual information of the business card submitted by the user A matches the business card information stored by the registered user; if yes, proceed to Step D4; otherwise, proceed to Step D7.

Step D4: Determine whether the user storing the business card stores multimedia information associated with the business card; if yes, proceed to Step D5; otherwise, proceed to Step D8.

Step D5: Determine whether the user storing the business card allows the user A, submitting the request, to obtain the information; if yes, proceed to Step D6; otherwise, proceed to Step D8.

Step D6: Return the found multimedia information stored by the business card owner on the website and associated with the business card, proceed to Step D9, and end.

Step D7: Determine whether business card information stored by all registered users of the website is checked; if yes, proceed to Step D8; otherwise, proceed to Step D1 to obtain and match business card information stored by a next registered user of the website.

Step D8: Return inquery failure, proceed to D9, and end.

Step D9: End.

According to a preferred solution of the present invention, in Step D2, the being different in only a few of characters refers to that the number of characters that incur the difference is not greater than one eighth of the total number of the characters of the item.

According to a preferred solution of the present invention, in Step D3, a method to determine whether the textual information of the business card submitted by the user A matches the business card information stored by the registered user is as follows. If the number of items of information being completely consistent is greater than half the total number of the items of information, or if at least one item of information is completely consistent and all corresponding information is different in only a few of characters, it is regarded that the textual information of the business card submitted by the user A matches the business card information stored by the registered user; otherwise, it is regarded that the textual information of the business card submitted by the user A does not match the business card information stored by the registered user.

According to a preferred solution of the present invention, in Step E, the contact information server returns the multimedia information stored by the business card owner being the user B on the website and associated with the business card to the user A. A method to return the multimedia information may be that the user A downloads the multimedia information completely, so that the information can be browsed without network connection; or may be that the user A only keeps a network link of the multimedia information, so that the information can only be browsed through network connection.

A method for obtaining information provided by contacts via network after inputting contact information includes the following steps.

Step 101: A user A obtains a business card of a user B.

Step 102: The user A inputs information in the business card of the user B into an address book.

Step 103: The user A, according to textual information in the business card of the user B, sends a inquery request to a server of a website siteC maintaining contact person information.

Step 104: The server of the website siteC maintaining the contact person information determines, according to the textual information of the business card submitted by the user A, whether multimedia information, stored by a business card owner being the user B, on the website and associated with the business card can be found; if yes, proceed to Step 105; otherwise, proceed to Step 106.

Step 105: The server of the website siteC returns the multimedia information stored by the business card owner being the user B on the website and associated with the business card to the user A.

Step 106: The server of the website siteC returns that no information associated with the business card can be provided.

Step 107: End.

According to a preferred solution of the present invention, in Step 102, the user A may input the information in the business card of the user B into the address book through one of the following methods.

In a first method, the user A directly manually inputs the information on the business card of the user B.

In a second method, the user A obtains an image of the business card of the user B by photographing, and then uses business card recognition software to automatically recognize and extract information in the image of the business card of the user B.

According to a preferred solution of the present invention, in Step 104, the server of the website siteC maintaining the contact person information determines, according to the textual information of the business card submitted by the user A, whether the multimedia information stored by the business card owner being the user B on the website and associated with the business card can be found; the server of the website siteC is required to determine whether the business card owner being the user B is a registered user of the website siteC, whether the business card owner being the user B stores the information associated with the business card, and whether the business card owner being the user B allows the user A, submitting the request, to obtain the information.

According to a preferred solution of the present invention, the method for the server of the website siteC to perform inquery regarding the user B specifically includes the following steps.

Step 201: Obtain information of a business card stored by a registered user of the website.

Step 202: Match a name, a phone number, a mobile phone number, a fax number and E-mail information included in the textual information of the business card submitted by the user A with corresponding information in the business card information item by item, so as to obtain that some items of information are completely consistent, and some items of information are different in only a few of characters.

Step 203: Determine whether the textual information of the business card submitted by the user A matches the business card information stored by the registered user; if yes, proceed to Step 204; otherwise, proceed to Step 207.

Step 204: Determine whether the user storing the business card stores multimedia information associated with the business card; if yes, proceed to Step 205; otherwise, proceed to Step 208.

Step 205: Determine whether the user storing the business card allows the user A, submitting the request, to obtain the information; if yes, proceed to Step 206; otherwise, proceed to Step 208.

Step 206: Return the found multimedia information stored by the business card owner on the website and associated with the business card, proceed to Step 209, and end.

Step 207: Determine whether business card information stored by all registered users of the website is checked; if yes, proceed to Step 208; otherwise, proceed to Step 201 to obtain and match business card information stored by a next registered user of the website.

Step 208: Return inquery failure, proceed to 209, and end.

Step 209: End.

According to a preferred solution of the present invention, in Step 202, the being different in only a few of characters refers to that the number of characters that incur the difference is not greater than one eighth of the total number of the characters of the item. In Step 203, a method to determine whether the textual information of the business card submitted by the user A matches the business card information stored by the registered user is as follows. If the number of items of information being completely consistent is greater than half the total number of the items of information, or if at least one item of information is completely consistent and all corresponding information is different in only a few of characters, it is regarded that the textual information of the business card submitted by the user A matches the business card information stored by the registered user; otherwise, it is regarded that the textual information of the business card submitted by the user A does not match the business card information stored by the registered user.

According to a preferred solution of the present invention, in Step 105, the server of the website siteC returns the multimedia information stored by the business card owner being the user B on the website and associated with the business card to the user A. A method to return the multimedia information may be that the user A downloads the multimedia information completely, so that the information can be browsed without network connection; or may be that the user A only keeps a network link of the multimedia information, so that the information can only be browsed through network connection.

A method for obtaining information provided by contacts via network after inputting contact information includes the following steps.

Step A: A user A obtains contact information of a user B.

Step B: The user A inputs the contact information of the user B into an address book.

Step C: The user A sends a inquery request to a contact information server according to the contact information of the user B.

Step D′: According to the contact information submitted by user A, the contact information server searches the information stored in the server to find out whether there is some information from user B related to the contact information; if yes, return relevant information to the user A; otherwise, inform the user A that no relevant information exists.

Implementation of the present invention requires a website having a contact person information maintaining function. A registered user of the website may store business card information thereof, which includes an image and textual information of the business card, on the website. The registered user of the website may further store various multimedia information including text, a picture, a video, and an audio, which is associated with the stored business card information thereof. The registered user of the website may set rights of the multimedia information, and stipulate that only specified users can obtain or browse the information or all users can obtain or browse the information. The business card owner is a registered user of the website. A user inputting the business card may be a registered user of the website, or may not be a registered user of the website.

Beneficial effects of the present invention are as follows. The present invention provides the method for obtaining information provided by contacts via network after inputting contact information, so that a user receiving a business card, after inputting business card information, can connect a specific website to obtain multimedia information pre-stored by a business card owner on the website and associated with the business card. The method eliminates the limit that a business card can only transfer information through a limited quantity of text and through limited size of a picture, so as to increase the quantity of information borne and transferred by the business card and add a manifestation of information.

### BRIEF DESCRIPTION OF THE DRAWINGS

FIG. 1 is a flow chart of a method according to the present invention.

FIG. 2 is a flow chart of Step 104 of a method according to the present invention.

### DETAILED DESCRIPTION OF THE PREFERRED EMBODIMENTS

Preferred embodiments of the present invention are described below in detail with reference to the accompanying drawings.

### Embodiment 1

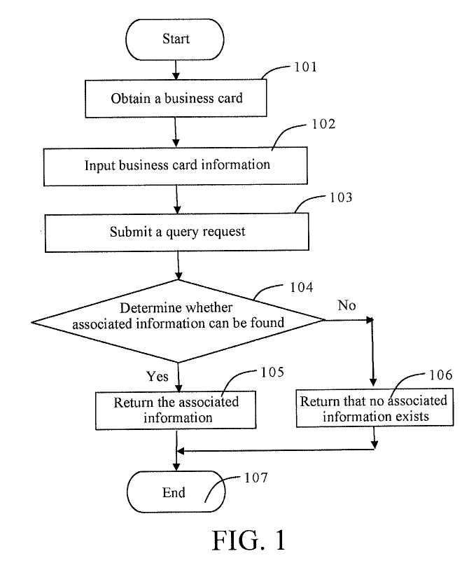

Referring to FIG. 1, the present invention provides a method for obtaining information provided by contacts via network after inputting contact information. The method includes the following steps.

Step 101: A user A obtains a business card of a user B.

The user A may obtain the business card of the user B through many methods, such as business card exchange performed during a business meeting or a gathering of friends, and handing around of a business card during product promotion.

Step 102: The user A inputs information in the business card of the user B into an address book.

The user A may input the information in the business card of the user B into the address book through the following methods.

In a first method, the user A directly manually inputs the information on the business card of the user B.

In a second method, the user A obtains an image of the business card of the user B by photographing, and then uses business card recognition software to automatically recognize and extract information in the image of the business card of the user B.

Step 103: The user A, according to textual information in the business card of the user B, sends a inquery request to a server of a website siteC maintaining contact person information. The website siteC has a contact person information maintaining function. A registered user of the website may store business card information thereof, which includes the image and the textual information of the business card, on the website. The registered user of the website may further store various multimedia information including text, a picture, a video, and an audio, which is associated with the stored business card information thereof.

Step 104: The server of the website siteC maintaining the contact person information determines, according to the textual information of the business card submitted by the user A, whether multimedia information, stored by a business card owner being the user B, on the website and associated with the business card can be found; if yes, proceed to Step 105; otherwise, proceed to Step 106.

In Step 104, the server of the website siteC maintaining the contact person information determines, according to the textual information of the business card submitted by the user A, whether the multimedia information stored by the business card owner being the user B on the website and associated with the business card can be found; the server of the website siteC is required to determine whether the business card owner being the user B is a registered user of the website siteC, whether the business card owner being the user B stores the information associated with the business card, and whether the business card owner being the user B allows the user A, submitting the request, to obtain the information.

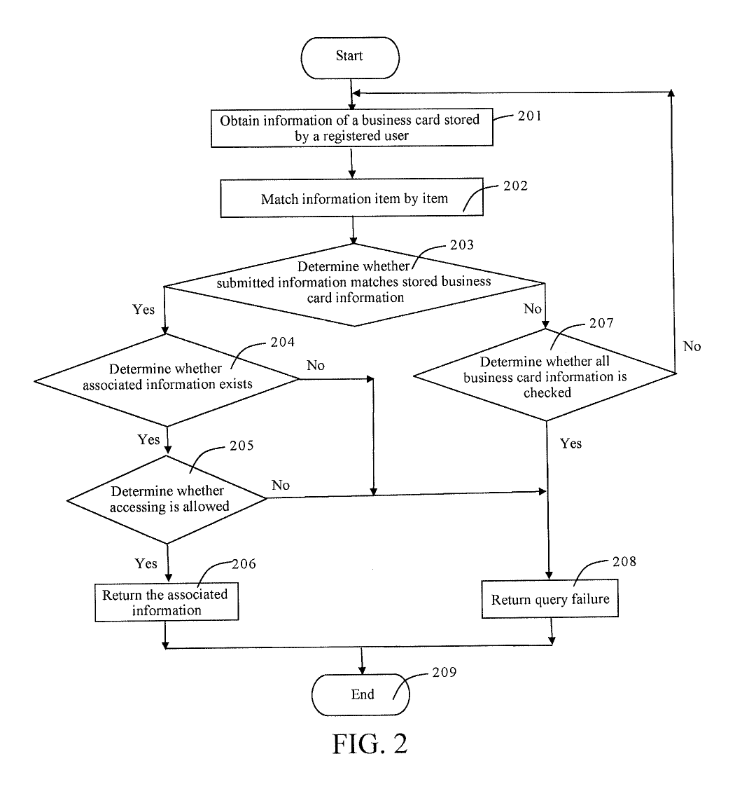

Referring to FIG. 2, FIG. 2 illustrates an implementation method of Step 104, which specifically includes the following steps.

Step 201: Obtain information of a business card stored by a registered user of the website.

Step 202: Match information such as a name, a phone number, a mobile phone number, a fax number and an E-mail address included in the textual information of the business card submitted by the user A with corresponding information in the business card information item by item, so as to obtain that some items of information are completely consistent, and some items of information are different in only a few of characters. The being different in only a few of characters refers to that the number of characters that incur the difference is not greater than one eighth of the total number of the characters of the item.

Step 203: Determine whether the textual information of the business card submitted by the user A matches the business card information stored by the registered user; if yes, proceed to Step 204; otherwise, proceed to Step 207. A method to determine whether the textual information of the business card submitted by the user A matches the business card information stored by the registered user is as follows. If the number of items of information being completely consistent is greater than half the total number of the items of information, or if at least one item of information is completely consistent and all corresponding information is different in only a few of characters, it is regarded that the textual information of the business card submitted by the user A matches the business card information stored by the registered user; otherwise, it is regarded that the textual information of the business card submitted by the user A does not match the business card information stored by the registered user.

Step 204: Determine whether the user storing the business card stores multimedia information associated with the business card; if yes, proceed to Step 205; otherwise, proceed to Step 208.

Step 205: Determine whether the user storing the business card allows the user A, submitting the request, to obtain the information; if yes, proceed to Step 206; otherwise, proceed to Step 208.

Step 206: Return the found multimedia information stored by the business card owner on the website and associated with the business card, proceed to Step 209, and end.

Step 207: Determine whether business card information stored by all registered users of the website is checked; if yes, proceed to Step 208; otherwise, proceed to Step 201 to obtain and match business card information stored by a next registered user of the website.

Step 208: Return inquery failure, proceed to 209, and end.

Step 209: End.

Step 105: The server of the website siteC returns the multimedia information stored by the business card owner being the user B on the website and associated with the business card to the user A.

In Step 105, the server of the website siteC returns the multimedia information stored by the business card owner being the user B on the website and associated with the business card to the user A. A method to return the multimedia information may be that the user A downloads the multimedia information completely, so that the information can be browsed without network connection; or may be that the user A only keeps a network link of the multimedia information, so that the information can only be browsed through network connection.

Step 106: The server of the website siteC returns information indicating that no information associated with the business card can be provided.

Step 107: End.

In view of the above, the present invention provides the method for obtaining information provided by contacts via network after inputting contact information, so that a user receiving a business card, after inputting business card information, can connect a specific website to obtain multimedia information pre-stored by a business card owner on the website and associated with the business card. The method eliminates the limit that a business card can only transfer information through a limited quantity of text and through limited size of a picture, so as to increase the quantity of information borne and transferred by the business card and add a manifestation of information.

### Embodiment 2

The embodiment provides a method for obtaining information provided by contacts via network after inputting contact information. The method includes the following steps.

Step A: A user A obtains contact information of a user B.

Step B: The user A inputs the contact information of the user B into an address book.

Step C: The user A sends a inquery request to a contact information server according to the contact information of the user B.

Step D: According to the contact information submitted by user A, the contact information server searches the information stored in the server to find out whether there is some information from user B related to the contact information; if yes, proceed to Step E; otherwise, proceed to Step F.

Step E: The contact information server returns the information stored by the user B on the website and associated with the contact information to the user A.

Step F: The contact information server returns that no information associated with the contact information can be provided.

Step G: End.

In Step B, the user A inputs the contact information of the user B into the address book through one of the following methods.

In a first method, the user A directly manually inputs the contact information of the user B.

In a second method, the user A obtains an image including the contact information of the user B by photographing or scanning, and uses character recognition software to automatically recognize and extract information in the image.

In Step D, the contact information server determines, according to the contact information submitted by the user A, whether the multimedia information stored by the user B on the server and associated with the contact information can be found. The contact information server is required to determine whether the user B is a registered user of the contact information server, whether the user B stores the information associated with the business card, and whether the user B allows other users, submitting a request, to obtain the information.

In the embodiment, the method for the contact information server to perform inquery regarding the user B includes the following steps.

Step D1: Obtain information of a business card stored by a registered user of the contact information server.

Step D2: Match a name, a phone number, a mobile phone number, a fax number and E-mail information included in the textual information of the business card submitted by the user A with corresponding information in the business card information item by item, so as to obtain the number of items of information that is completely consistent, and the number of items of information that is different in only a few of characters.

Step D3: Determine whether the textual information of the business card submitted by the user A matches the business card information stored by the registered user; if yes, proceed to Step D4; otherwise, proceed to Step D7.

Step D4: Determine whether the user storing the business card stores multimedia information associated with the business card; if yes, proceed to Step D5; otherwise, proceed to Step D8.

Step D5: Determine whether the user storing the business card allows the user A, submitting the request, to obtain the information; if yes, proceed to Step D6; otherwise, proceed to Step D8.

Step D6: Return the found multimedia information stored by the business card owner on the website and associated with the business card, proceed to Step D9, and end.

Step D7: Determine whether business card information stored by all registered users of the website is checked; if yes, proceed to Step D8; otherwise, proceed to Step D1 to obtain and match business card information stored by a next registered user of the website.

Step D8: Return inquery failure, proceed to D9, and end.

Step D9: End.

In Step D2, the being different in only a few of characters refers to that the number of characters that incur the difference is not greater than one eighth of the total number of the characters of the item.

In Step D3, a method to determine whether the textual information of the business card submitted by the user A matches the business card information stored by the registered user is as follows. If the number of items of information being completely consistent is greater than half the total number of the items of information, or if at least one item of information is completely consistent and all corresponding information is different in only a few of characters, it is regarded that the textual information of the business card submitted by the user A matches the business card information stored by the registered user; otherwise, it is regarded that the textual information of the business card submitted by the user A does not match the business card information stored by the registered user.

In Step E, the contact information server returns the multimedia information stored by the business card owner being the user B on the website and associated with the business card to the user A. A method to return the multimedia information may be that the user A downloads the multimedia information completely, so that the information can be browsed without network connection; or may be that the user A only keeps a network link of the multimedia information, so that the information can only be browsed through network connection.

The description and application of the present invention here are merely for exemplary purpose, and are not intended to limit the scope of the present to the above embodiments. The variations and modifications of the embodiments disclosed herein are possible, and for persons with ordinary skill in the art, the replacement and various equivalent parts in the present invention are publicly known. It should be noted for persons skilled in the art that, the present invention may be implemented through other forms, structures, arrangements, proportions and other components, materials and parts without departing from the spirit and essential features of the present invention. Other deformations and variations may be made to the embodiments disclosed here without departing from the scope and spirit of the present invention.

What is claimed is:

1. A method for obtaining information provided by contacts via network after inputting contact information, comprising:
Step A: a user A obtaining contact information of a user B;
Step B: the user A inputting the contact information of the user B into an address book;
Step C: the user A sending a inquery request to a contact information server according to the contact information of the user B;
Step D: according to the contact information submitted by user A, the contact information server searches the information stored in the server to find out whether there is some information from user B related to the contact information; if yes, proceeding to Step E; otherwise, proceeding to Step F;
Step E: the contact information server returning the information stored by the user B on the website and associated with the contact information to the user A;
Step F: the contact information server returning that no information associated with the contact information is able to be provided; and
Step G: ending.

2. The method for obtaining information provided by contacts via network after inputting contact information as in claim 1, wherein
in Step B, the user A inputs the contact information of the user B into the address book through one of the following methods:
in a first method, the user A directly manually inputs the contact information of the user B; and
in a second method, the user A obtains an image comprising the contact information of the user B by photographing or scanning, and uses character recognition software to automatically recognize and extract information in the image.

3. The method for obtaining information provided by contacts via network after inputting contact information as in claim 1, wherein
in Step D, the contact information server determines, according to the contact information submitted by the user A, whether multimedia information stored by the user B on the server and associated with the contact information is able to be found; and
the contact information server is required to determine whether the user B is a registered user of the contact information server, whether the user B stores the information associated with the business card, and whether the user B allows other users, who have submitted a request, to obtain the information.

4. The method for obtaining information provided by contacts via network after inputting contact information as in claim 3, wherein
the method for the contact information server to perform inquery regarding the user B comprises the following steps:
Step D1: obtaining information of a business card stored by a registered user of the contact information server;
Step D2: matching a name, a phone number, a mobile phone number, a fax number and E-mail information comprised in the textual information of the business card submitted by the user A with corresponding information in the business card information item by item, so as to obtain the number of items of information that is completely consistent, and the number of items of information that is different in only a few of characters;
Step D3: determining whether the textual information of the business card submitted by the user A matches the business card information stored by the registered user; if yes, proceeding to Step D4; otherwise, proceeding to Step D7;
Step D4: determining whether the user storing the business card stores multimedia information associated with the business card; if yes, proceeding to Step D5; otherwise, proceeding to Step D8;
Step D5: determining whether the user storing the business card allows the user A, submitting the request, to obtain the information; if yes, proceeding to Step D6; otherwise, proceeding to Step D8;
Step D6: returning the found multimedia information stored by the business card owner on the website and associated with the business card, proceeding to Step D9, and ending;
Step D7: determining whether business card information stored by all registered users of the website is checked; if yes, proceeding to Step D8; otherwise, proceeding to Step D1 to obtain and match business card information stored by a next registered user of the website;
Step D8: returning inquery failure, proceeding to D9, and ending.
Step D9: ending.

5. The method for obtaining information provided by contacts via network after inputting contact information as in claim 4, wherein
in Step D2, the being different in only a few of characters refers to that the number of characters that incur the difference is not greater than one eighth of the total number of the characters of the item.

6. The method for obtaining information provided by contacts via network after inputting contact information as in claim 4, wherein
in Step D3, a method to determine whether the textual information of the business card submitted by the user A matches the business card information stored by the registered user is:
if the number of items of information being completely consistent is greater than half the total number of the items of information, or if at least one item of information is completely consistent and all corresponding information is different in only a few of characters, regarding that the textual information of the business card submitted by the user A matches the business card information stored by the registered user; otherwise, regarding that the textual information of the business card submitted by the user A does not match the business card information stored by the registered user.

7. The method for obtaining information provided by contacts via network after inputting contact information as in claim 1, wherein
in Step E: the contact information server returns the multimedia information stored by the business card owner being the user B on the website and associated with the business card to the user A; and
a method to return the multimedia information is that the user A downloads the multimedia information completely, so that the information is able to be browsed without network connection; or is that the user A only keeps a network link of the multimedia information, so that the information is only able to be browsed through network connection.

8. A method for obtaining information provided by contacts via network after inputting contact information, comprising:
Step 101: a user A obtaining a business card of a user B;
Step 102: the user A inputting information in the business card of the user B into an address book;
Step 103: the user A, according to textual information in the business card of the user B, sending a inquery request to a server of a website siteC maintaining contact person information;
Step 104: the server of the website siteC maintaining the contact person information determining, according to the textual information of the business card submitted by the user A, whether multimedia information, stored by a business card owner being the user B, on the website and associated with the business card is able to be found; if yes, proceeding to Step 105; otherwise, proceeding to Step 106;
Step 105: the server of the website siteC returning the multimedia information stored by the business card owner being the user B on the website and associated with the business card to the user A;
Step 106: the server of the website siteC returning that no information associated with the business card is able to be provided; and
Step 107: ending.

9. The method for obtaining information provided by contacts via network after inputting contact information as in claim 8, wherein
in Step 102, the user A inputs the information in the business card of the user B into the address book through one of the following methods:
in a first method, the user A directly manually inputs the information on the business card of the user B; and
in a second method, the user A obtains an image of the business card of the user B by photographing, and then uses business card recognition software to automatically recognize and extract information in the image of the business card of the user B.

10. The method for obtaining information provided by contacts via network after inputting contact information as in claim 8, wherein
in Step 104, the server of the website siteC maintaining the contact person information determines, according to the textual information of the business card submitted by the user A, whether the multimedia information stored by the business card owner being the user B on the website and associated with the business card is able to be found; the server of the website siteC is required to determine whether the business card owner being the user B is a registered user of the website siteC, whether the business card owner being the user B stores the information associated with the business card, and whether the business card owner being the user B allows the user A, submitting the request, to obtain the information.

11. The method for obtaining information provided by contacts via network after inputting contact information as in claim 8, wherein
a method for the server of the website siteC to perform inquery regarding the user B specifically comprises the following steps:
Step 201: obtaining information of a business card stored by a registered user of the website;
Step 202: matching a name, a phone number, a mobile phone number, a fax number and E-mail information comprised in the textual information of the business card submitted by the user A with corresponding information in the business card information item by item, so as to obtain that some items of information are completely consistent, and some items of information are different in only a few of characters;
Step 203: determining whether the textual information of the business card submitted by the user A matches the business card information stored by the registered user; if yes, proceeding to Step 204; otherwise, proceeding to Step 207;
Step 204: determining whether the user storing the business card stores multimedia information associated with the business card; if yes, proceeding to Step 205; otherwise, proceeding to Step 208;
Step 205: determining whether the user storing the business card allows the user A, submitting the request, to obtain the information; if yes, proceeding to Step 206; otherwise, proceeding to Step 208;
Step 206: returning the found multimedia information stored by the business card owner on the website and associated with the business card, proceeding to Step 209, and ending;
Step 207: determining whether business card information stored by all registered users of the website is checked; if yes, proceeding to Step 208; otherwise, proceeding to Step 201 to obtain and match business card information stored by a next registered user of the website;
Step 208: returning inquery failure, proceeding to 209, and ending; and
Step 209: ending.

12. The method for obtaining information provided by contacts via network after inputting contact information as in claim 9, wherein
in Step 202, the being different in only a few of characters refers to that the number of characters that incur the difference is not greater than one eighth of the total number of the characters of the item; and
in Step 203, a method to determine whether the textual information of the business card submitted by the user A matches the business card information stored by the registered user is: if the number of items of information being completely consistent is greater than half the total number of the items of information, or if at least one item of information is completely consistent and all corresponding information is different in only a few of characters, regarding that the textual information of the business card submitted by the user A matches the business card information stored by the registered user; otherwise, regarding that the textual information of the business card submitted by the user A does not match the business card information stored by the registered user.

13. The method for obtaining information provided by contacts via network after inputting contact information as in claim 8, wherein
in Step 105, the server of the website siteC returns the multimedia information stored by the business card owner being the user B on the website and associated with the business card to the user A; a method to return the multimedia information is that the user A downloads the multimedia information completely, so that the information is able to be browsed without network connection; or is that the user A only keeps a network link of the multimedia information, so that the information is only able to be browsed through network connection.

14. A method for obtaining information provided by contacts via network after inputting contact information, comprising:
Step A: a user A obtaining contact information of a user B;
Step B: the user A inputting the contact information of the user B into an address book;
Step C: the user A sending a inquery request to a contact information server according to the contact information of the user B; and
Step D′: the contact information server determining, according to the contact information submitted by the user A, whether information stored by the user B on the server and associated with the contact information is able to be found; if yes, returning relevant information to the user A; otherwise, informing the user A that no relevant information exists.
